(19) United States
(12) Patent Application Publication
(10) Pub. No.: US 2015/0057074 A1
(43) Pub. Date: Feb. 26, 2015

(54) DIFFERENTIAL-BASED FANTASY-SPORTS GAMING

(71) Applicants: David Geller, Los Angeles, CA (US); Edwin Pankau, Los Angeles, CA (US); Tyler Andersen, Sherman Oaks, CA (US); Dean Nakabayashi, San Francisco, CA (US)

(72) Inventors: David Geller, Los Angeles, CA (US); Edwin Pankau, Los Angeles, CA (US); Tyler Andersen, Sherman Oaks, CA (US); Dean Nakabayashi, San Francisco, CA (US)

(21) Appl. No.: 14/464,312

(22) Filed: Aug. 20, 2014

Related U.S. Application Data
(60) Provisional application No. 61/867,714, filed on Aug. 20, 2013.

(51) Int. Cl. A63F 13/828; A63F 13/46

(52) U.S. Cl. CPC A63F 13/828; A63F 13/46
USPC 463/25; 463/43

(57) ABSTRACT

A set of projected performance data for an upcoming performance of real-world athletes is used to create a projected point value corresponding to the projected performance of each real-world athlete. A user of a client device selects one or more athletes that the user deems most likely to improve on their projected points. When the real-world games begin, a difference between the projected fantasy-sports point totals (which may be equalized by providing a handicap) is used to declare a winner of the fantasy-sports game.

### CROSS-REFERENCE TO RELATED APPLICATIONS

This application claims priority to and the benefit of U.S. Provisional Patent Application Ser. No. 61/867,714, filed on Aug. 20, 2013, which is hereby incorporated herein by reference in its entirety.

### TECHNICAL FIELD

Embodiments of the present invention relate generally to sports and gaming and, in particular, to participating in fantasy-sports competitions.

### BACKGROUND

A “fantasy sport” is a game in which participants select a number of real-world players from a one or more real-world teams in a sports league and compete against other fantasy participants based on the performance statistics generated by the real-world players in real-world games. Fantasy sports may be played with pen and paper, but increasingly, online services and software allow participants to more easily select their teams, track the performance of their players, and tally their results. The ease of use of these online services removes much of the drudgery of tracking fantasy-sport statistics and has thereby caused the popularity of fantasy sports to skyrocket.

Even so, however, participation in a fantasy-sports league is a long-term endeavor stretching out over an entire sports season, which can last six months or more. Participants in fantasy-sports league may grow weary of it and quit before the season is over; other people may choose not to participate at all. A need therefore exists for a way to provide the interest and thrill of participation in a fantasy-sports league without the long-term time and energy commitment.

### SUMMARY

In general, various aspects of the systems and methods described herein relate to fantasy-sports games that may be created, set up, and kicked off in relatively little time. In various embodiments, a set of projected performance data for an upcoming performance of real- world athletes is used to create a projected point value corresponding to the projected performance of each real-world athlete. A user of a client device selects one or more athletes that the user deems most likely to improve on their projected points. When the real-world games begin, a difference between the projected fantasy-sports point totals (which may be equalized by providing a handicap) is used to declare a winner of the fantasy-sports game.

In one aspect, a method for conducting a fantasy-sports game includes storing, in a computer database, a set of projected performance data for an upcoming performance of real-world athletes; computing using a computer processor, for each real-world athlete, a projected point value corresponding to the projected performance of each real-world athlete; transmitting using an electronic network, to a client device of a user, the projected point values; receiving, from the client device of the user, a selection of real-world athletes to be included in the fantasy-sports game; determining a first projected fantasy-sports point total corresponding to a total projected point value of the real-world athletes selected by the user; determining a second projected fantasy-sports point total corresponding to a total projected point value of the real-world athletes selected by a competing user; equalizing a difference between the first and second projected fantasy-sports point totals by providing a handicap to the lesser of the first and second projected fantasy-sports point totals; and determining a winner of the fantasy-sports game, after the upcoming performance of the real-world athletes has occurred, based on whether fantasy-sports points earned by the selection of the user exceeds fantasy-sports points earned by the selection of the competing user when the handicap is included.

The number of real-world athletes selected by the user may be one, three, five, or seven. The real-world athletes may compete in football, baseball, basketball, or hockey. Providing the handicap may include awarding the user having a lower projected fantasy-sports point total additional points equal to a difference between the first projected fantasy-sports point total and the second projected fantasy-sports point total and/or tracking differences between (i) the first projected fantasy-sports point total and points earned by the selection of the user and (ii) the second projected fantasy-sports point total and points earned by the selection of the competing user and selecting the greater of the two differences. The upcoming performance may include a part of a game, a game, or a series of games. The selected real-world athletes may include one sports league or a plurality of sports leagues. Determining the winner may include comparing an absolute number of points or a percentage increase in points and/or selecting the user having the highest or lowest number of points. A cash or rewards-points prize may be awarded to the winner.

In another aspect, a system for conducting a fantasy-sports game includes a computer database for storing a set of projected performance data for an upcoming performance of real-world athletes; and a computer processor for executing software instructions. The instructions are for computing, for each real-world athlete, a projected point value corresponding to the projected performance of each real-world athlete; transmitting using an electronic network, to a client device of a user, the projected point values; receiving, from the client device of the user, a selection of real-world athletes to be included in the fantasy-sports game; determining a first projected fantasy-sports point total corresponding to a total projected point value of the real-world athletes selected by the user; determining a second projected fantasy-sports point total corresponding to a total projected point value of the real-world athletes selected by a competing user; equalizing a difference between the first and second projected fantasy-sports point totals by providing a handicap to the lesser of the first and second projected fantasy-sports point totals; and determining a winner of the fantasy-sports game, after the upcoming performance of the real-world athletes has occurred, based on whether fantasy-sports points earned by the selection of the user exceeds fantasy-sports points earned by the selection of the competing user when the handicap is included.

The number of real-world athletes selected by the user may be one, three, five, or seven. The real-world athletes may compete in football, baseball, basketball, or hockey. Providing the handicap may include awarding the user having a lower projected fantasy-sports point total additional points equal to a difference between the first projected fantasy-sports point total and the second projected fantasy-sports point total and/or tracking differences between (i) the first projected fantasy-sports point total and points earned by the selection of the user and (ii) the second projected fantasy-sports point total and points earned by the selection of the competing user and selecting the greater of the two differences. The upcoming performance may include a part of a game, a game, or a series of games. The selected real-world athletes may include one sports league or a plurality of sports leagues. Determining the winner may include comparing an absolute number of points or a percentage increase in points and/or selecting the user having the highest or lowest number of points. A cash or rewards-points prize may be awarded to the winner.

These and other objects, along with advantages and features of the present invention herein disclosed, will become more apparent through reference to the following description, the accompanying drawings, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. In the following description, various embodiments of the present invention are described with reference to the following drawings, in which:

FIG. 1 is a flowchart of a method for joining a fantasy-sports game in accordance with embodiments of the present invention;

FIGS. 2, 3, 4, and 5 are screenshots of a client interface in accordance with embodiments of the present invention;

FIG. 6 is a block diagram of a computing environment in accordance with embodiments of the present invention;

FIG. 7 is a block diagram of a client device in accordance with embodiments of the present invention;

FIG. 8 is a block diagram of a server in accordance with embodiments of the present invention; and

FIG. 9 is a flowchart of a method for creating a fantasy-sports game in accordance with embodiments of the present invention.

### DETAILED DESCRIPTION

In various embodiments of the present invention, a plurality of users select one or more real-world athletes currently participating in real-world sporting leagues. A prediction of the performance of the athletes is made based on their past performance, current health, predicted weather conditions, or any other such factors. After the selection is made, the athletes perform in one or more real-world games or competitions over the course of a day, week, or any other time period. The actual performance of the athletes is compared to their predicted performance, and the user who selected the athletes who exceeded their predicted performance by the widest margin is declared the winner. The users are thus encouraged to use their knowledge of the sport, the athletes, and/or the current conditions to select athletes most likely to out-perform their expected performances.

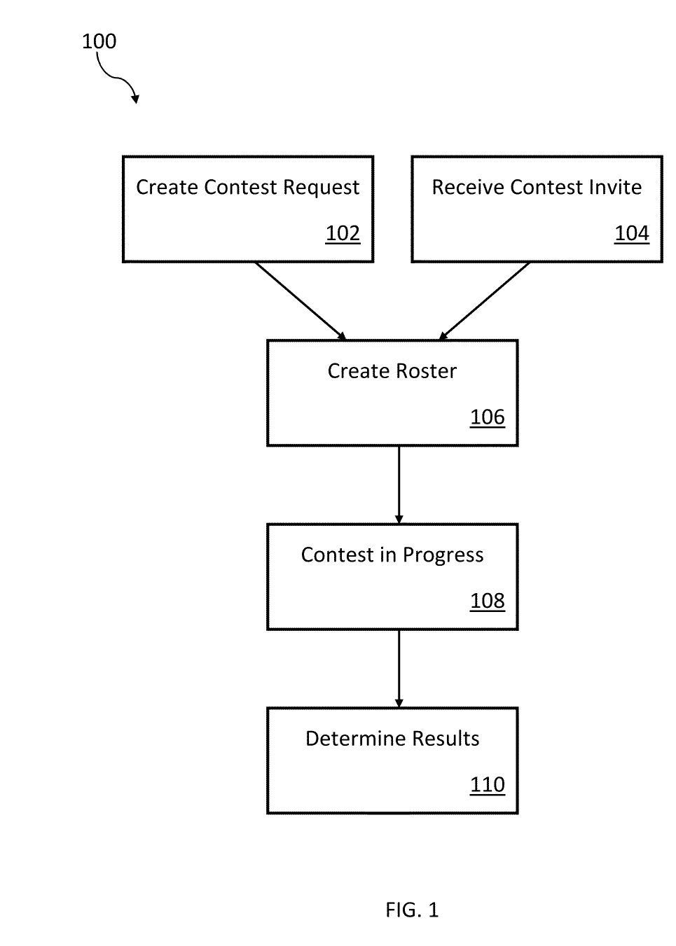

FIG. 1 illustrates a method 100 summarizing the creation of and participation in a fantasy-sports game in accordance with embodiments of the present invention; further details of each step are presented in greater detail below. In a first step 102, a user of a client device, such as a cellular telephone, tablet computer, desktop computer, laptop computer, or any other similar device requests the creation of a fantasy-sports contest using a mobile application, desktop application, or web-based interface. A request may thereafter be sent to one or more other users to join the contest. In alternative first step 104, a contest invite for an existing contest may be received from one or more other users.

Once a contest has been initiated, in a second step 106, the user may be presented with a user interface containing information about available real-world athletes, their past performance data, and/or their predicted future performance data. As explained in greater detail below, this performance data may be presented as a number of fantasy points that the athletes have earned or are expected to earn. The user may thus select three or more athletes to participate in their contest, referred to herein as a roster of athletes, with the goal of choosing said athletes that are most likely to out-perform their predicted performance. This out-performance is referred to herein as the “differential” between the predicted and actual performance. Other users participating in the contest may similarly select athletes.

In a third step 108, the contest is in progress while two or more real-world athletic events transpire. The contest may include a single real-world game, a plurality of real-world games, or a given time span in which a number of real-world games transpire. As explained in greater detail below, the user may monitor the progress of the accumulation of points earned by the selected athletes in real time against the total predicted points.

In a fourth step 110, when the required number of real-world events is fulfilled, a contest winner is determined. In one embodiment, the user who successfully predicted which athletes have the greatest positive performance differential is declared the winner; in other embodiments, as explained in greater detail below, the user who predicted the athletes having the greatest negative performance differential is declared the winner. In some embodiments, a handicap is used to equalize the chances of each user winning the contest (to account for, as explained in greater detail below, athletes having different amounts of predicted points).

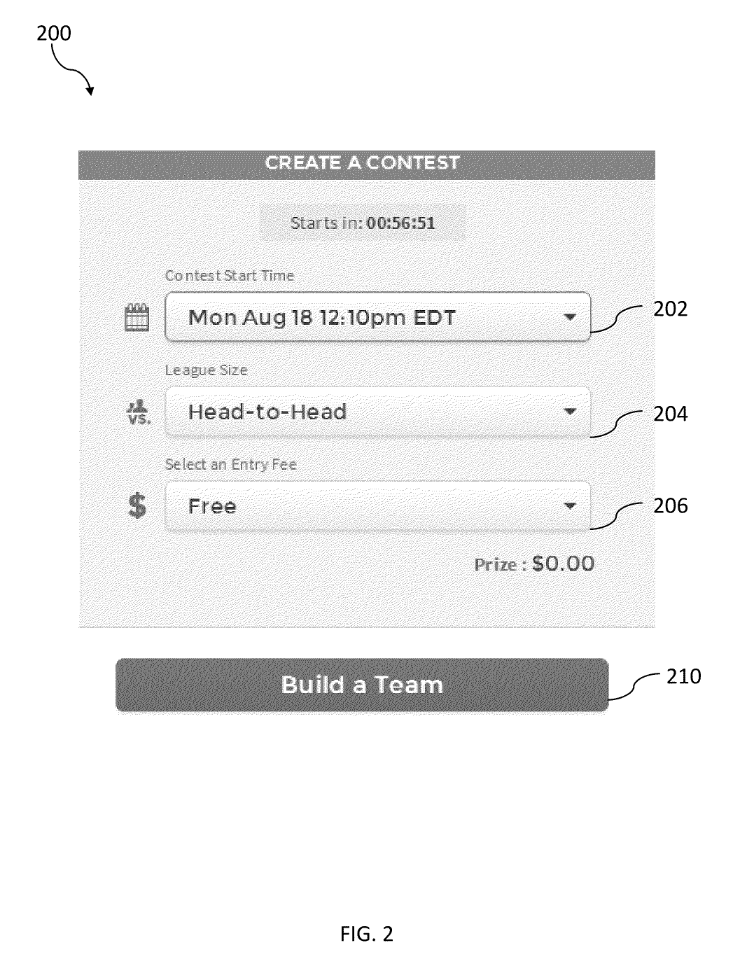

FIGS. 2, 3, and 4 depict a series of exemplary screenshots of a client interface with which a user may carry out some or all of the above-described steps. The present invention is not, however, limited to only the user interface depicted in said screenshots, and one of skill in the art will understand that any variations and permutations thereof are within the scope of the present invention. In FIG. 2, the interface 200 includes a first selection box 202 for selecting a contest start time, a second selection box 204 for selecting a contest type (as explained in greater detail below), and a third selection box 206 for selecting an entry fee (as, again, is explained in greater detail below). Once the selections 202, 204, 206 are made, the user may proceed to the next step, building a team or roster, by selecting the button 210.

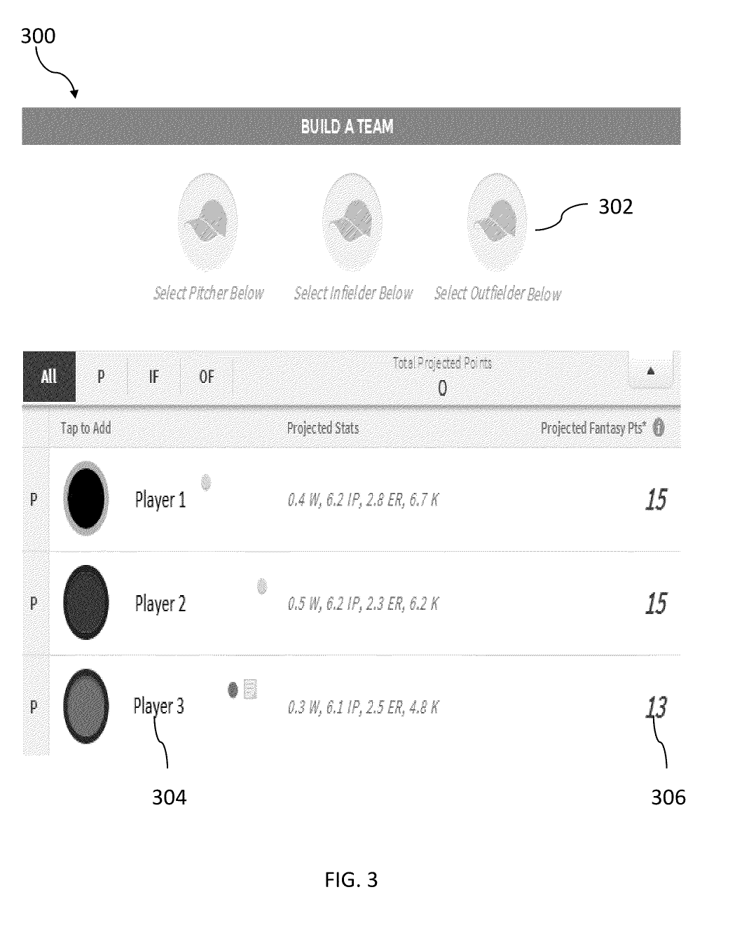

FIG. 3 depicts a screenshot 300 of an interface for building a team or roster. In this embodiment, a series of empty slots 302 are available for the user to fill with selected real-world athletes chosen from a selection menu 304. The interface 300 may allow the user to click-and-drag, touch-and-drag, double-click, or provide any other input means to indicate that one or more of the athletes in the selection menu 304 should be assigned to one of the empty slots 302. In this example, the sport is baseball, and the three selection slots 302 each accept athletes from predetermined positions (here, a pitcher, an infielder, and an outfielder). The present invention is not, however, limited to only this sport or selection constraints, and in other embodiments, varying number of slots 302 may be available (e.g., one, two, four, five, or more slots 302) and the slots 302 may or may not be constrained to predetermined positions.

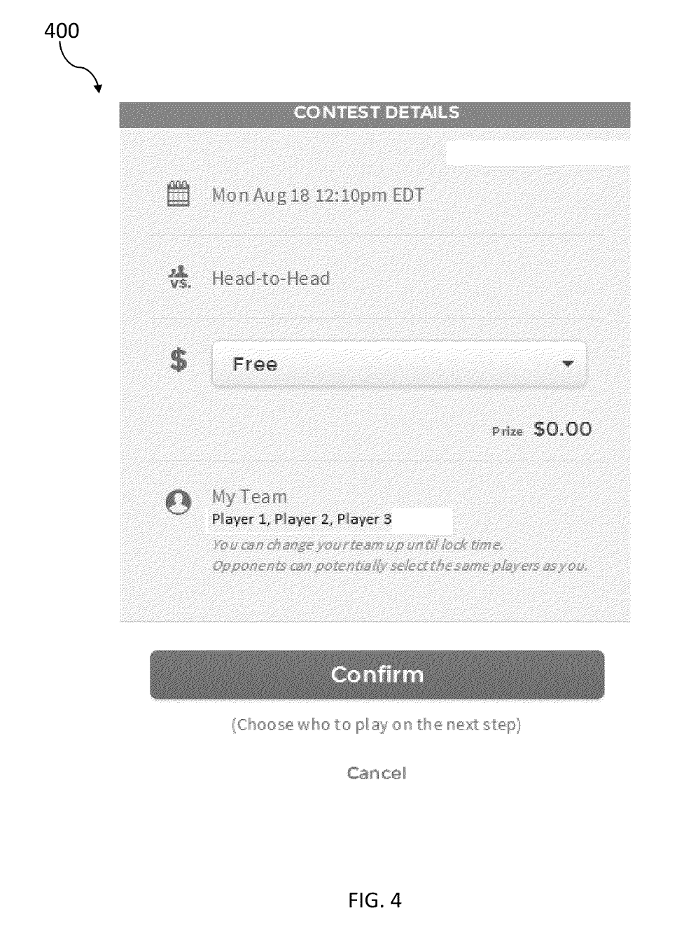

FIG. 3 further depicts a projected point value 306 for each of the athletes in the menu 304. As mentioned briefly above and explained in greater detail below, these point values 306 are used to predict the performance of, and points awarded to, the athletes in the menu 304. Higher-producing athletes may have higher predicted point values 306, while lesser-producing athletes may have lesser point values 306. As also explained in greater detail below, a handicap may be applied to equalize varying point values. FIG. 4 depicts a confirmation interface 400 with which a user may confirm his or her choices for time, contest type, entry fee, and team roster.

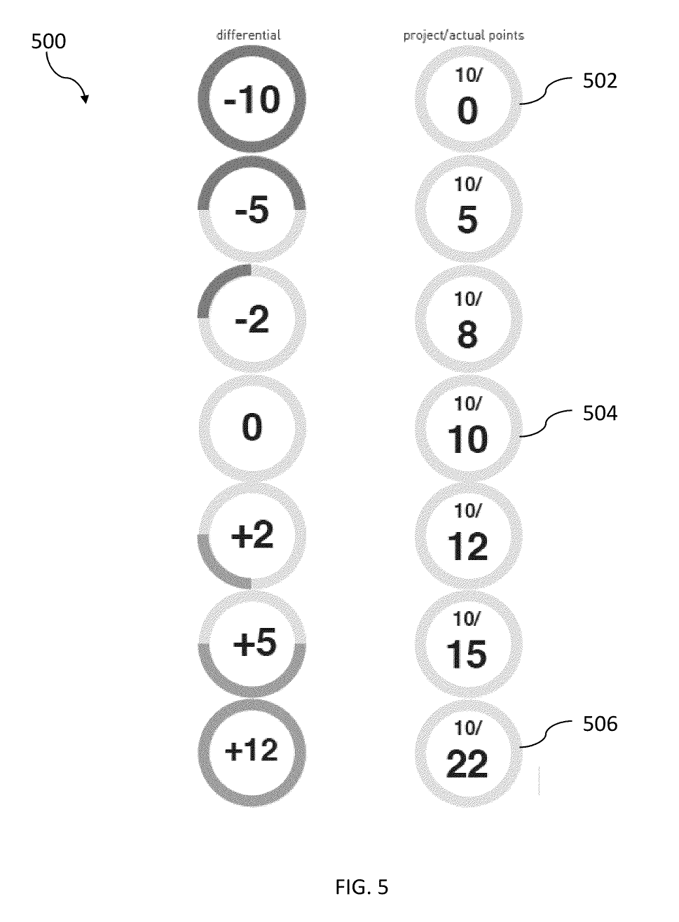

FIG. 5 depicts an interface 500 for monitoring a contest in progress. In this example, the user has selected a team roster having a total projected predicted point value of ten. When the contest begins, no points have yet been earned by the real-world athletes, and a first row 502 of the interface indicates that the user is ten points below the projection (“−10”) as well as indicating that zero of ten points have been earned (“10/0”). As the contest progresses and the roster earns points, the interface 500 changes accordingly; when, for example, the roster has earned ten points, the interface 500 changes to show another row 504 indicating that the differential is now zero (“0”) and that the total points earned are ten (“10/10”). If the roster earns additional points, the interface 500 changes still further; for example, if the roster earns twenty-two points, the interface 500 displays a new row 506 with this information (“+12” and “10/22”). Upon conclusion of the contest, the interface may display an indication of loss or victory, a summary of points earned by users in the contest, and any money or prizes won.

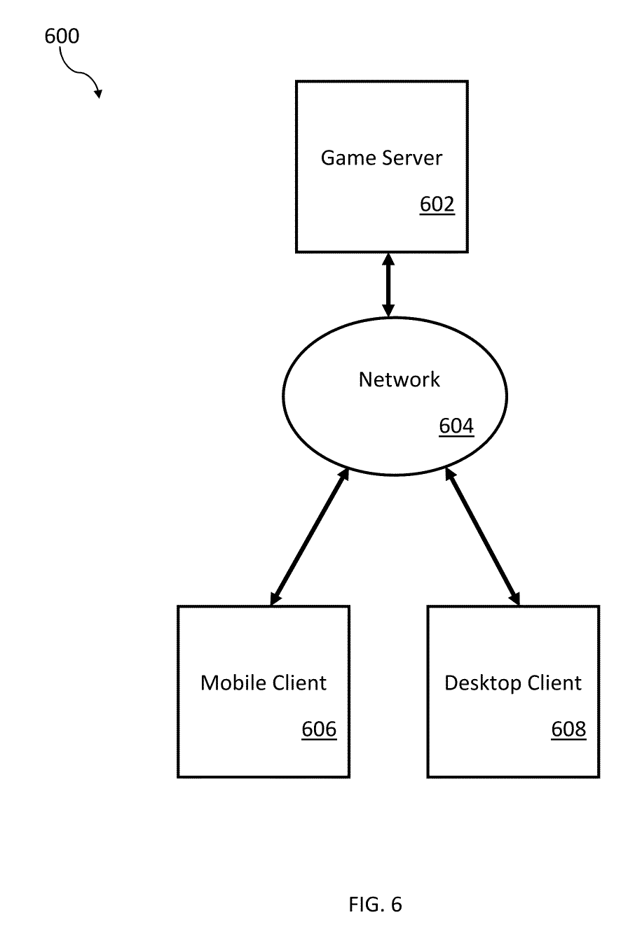

FIGS. 6, 7, and 8 depict block diagrams of a network environment 600, a client device 700, and a server 800 in accordance with various aspects of the present invention. One of skill in the art will understand, however, that the present invention is not limited to any particular network, client device, or server, and that various types of hardware and software are within its scope.

FIG. 6 illustrates a game server 602, a network 604, a mobile client device 606, and a desktop client device 608. The game server 602 conducts contests described briefly above and in greater detail below. Only one server 602 is shown, but the server 602 may include a group of servers mirrored to provide redundancy and speed and/or to provide local services to different geographic regions. The server 602 may be a dedicated computing device, part of cloud-based computing, or any other type of server, and may include a web server, file server, and/or application server. The network 604 may be any local or wide-area network, such as the Internet. Any number of client devices may communicate electronically with the server 602; an exemplary mobile client 606, such as a cell phone, and an exemplary desktop client 608, such as a web-browser-based application, are shown.

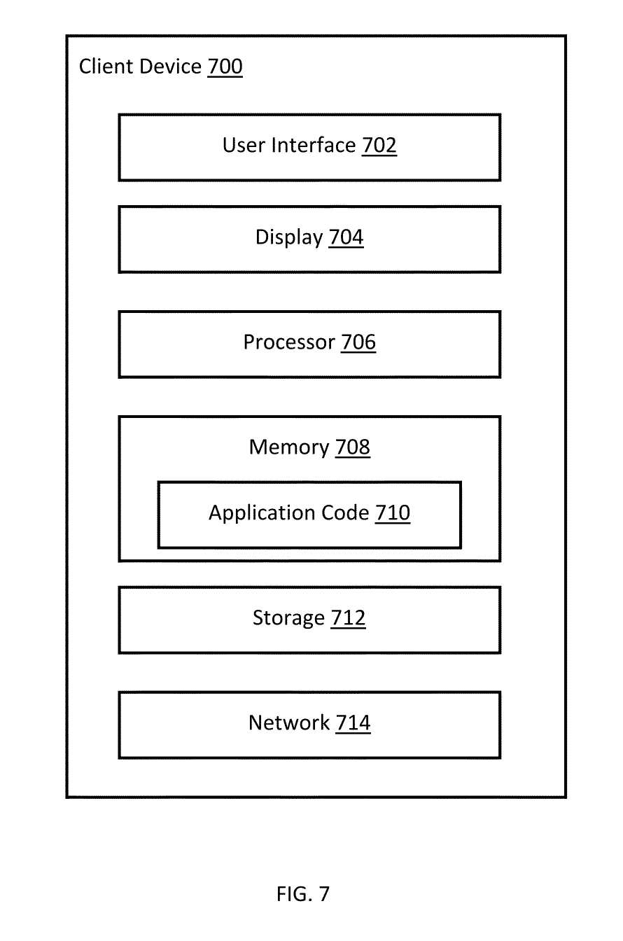

FIG. 7 illustrates a block diagram of a client device 700. The device 700 may be a cell phone, tablet computer, personal computer, laptop computer, or any other type of computing device. A user interface 702 may include a keyboard, mouse, voice interface, or any other type of user input hardware. A display 704 may be used to display a user interface to the user (such as the user interfaces depicted in FIGS. 2-5) and may be a touchscreen display. A computer processor 706, such as an INTEL PENTIUM processor, executes computer instructions stored in a volatile memory 708, such as RAM; these instructions may include C, C++, Java, Javascript, Ruby, or other instructions 710 to execute the embodiments of the invention disclosed herein. The instructions 710 may be a native application or part of a web page loaded on the device 700. The device 700 may also include non-volatile storage 712, such as a hard disk or FLASH memory, and a network interface 714, such as ETHERNET or WI-FI.

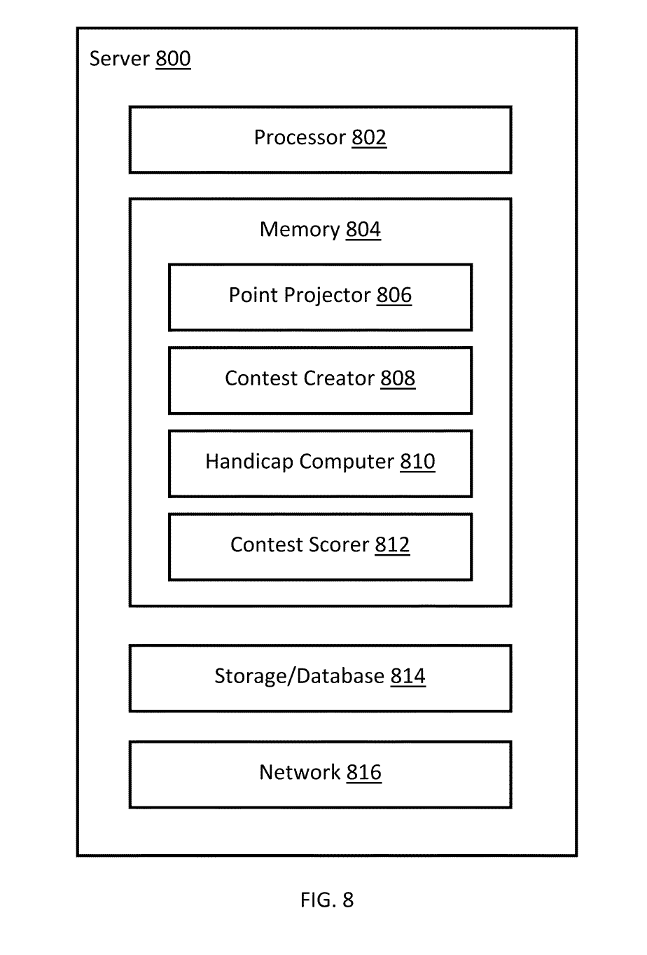

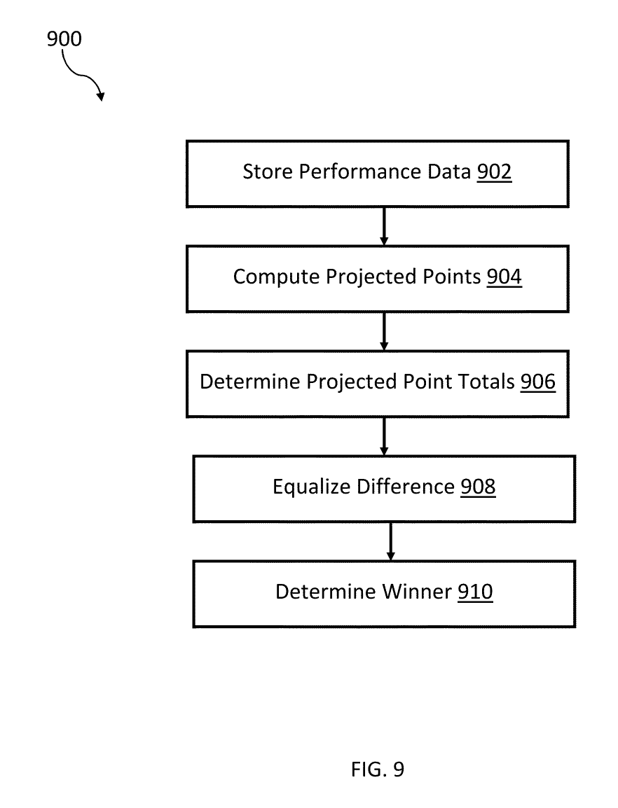

FIG. 8 illustrates a block diagram of a server 800. Like the client 700, the server may include a processor 802, memory 804, non-volatile storage 814 (which may include a database of performance or other data), and a network interface 816. The memory 804 may include program modules for creating projected point values 806, creating contests 808, computing a handicap 810, and scoring a contest 812. The program modules 806-812 may be written in C, C++, Java, Javascript, Ruby, or any other such language. One of skill in the art will understand, however, that the modules 806-812 are only one implementation of the present invention, and other combinations or divisions of the functionality implemented therein are within the scope of the present invention.

Various aspects of the present invention mentioned briefly above will now be described in greater detail. In one embodiment, the point projector 806 creates a set of point values based on performance data received and stored in the database 814. The performance data may be compiled by a third-party service such as NUMBERFIRE or similar services. In other embodiments, raw statistical data may be received and stored in the database 814 and/or created in-house, and the point projector 806 may compile point values directly therefrom. As an example, if the sport in question is football, point values may be computed by awarding 100 points for a touchdown, 1 point per yard for pass yards, 2 points per yard for rushing yards, −20 points for an interception, and −30 points for a fumble. Any other similar number values for football or any other sport are within the scope of the present invention.

As described above, the server 800 and the contest creator 808 may communicate with the client device 700 to present a user thereof with a selection of athletes and, potentially, associated projected point values. In one embodiment, the user selects a number of athletes (e.g., three) to complete a roster, and the selection is communicated back to the server 800. In other embodiments, the selection of the user may be constrained by a “salary cap,” i.e., a maximum dollar or point value. Each athlete may have an associated “salary”; the user may select one or more athletes only if their combined salaries are less than the salary cap. The salary cap and salaries may be any values; the salaries may reflect the skill, popularity, or tendency to out-perform projected points of an athlete. For example, the salary cap may be $50,000, and the salary for a skilled player may be $20,000 while the salary for an unskilled player may be $5,000.

In some embodiments, the contest creator 808 may permit the user to select between a number of different game types. The user may select one of a plurality of different sporting events, for example, such as baseball, basketball, football, or hockey. The present invention is not limited to any particular type of sport; however, any one of skill in the art will understand that the systems and methods of the present invention may be applied to any sport. Such other sports may include but are not limited to soccer, golf, cricket, rugby, horseracing, automobile racing, Australian-rules football, Olympic sports, or any other types of sports.

The user may further select a number of other users with which to compete. In one embodiment, a head-to-head or one-on-one contest may be selected in which one other user is selected (for a total of two contestants). The second user may be directly invited by the first via the software channel running on the client device or via the web-based interface; in other embodiments, the second user may be invited via an out-of-band channel such as by telephone, email, or social media. The second user may identify the first user and the contest by following a link provided by the first user, by searching for the first user's name or alias, or by any other means.

In a related embodiment, the user may select an open contest in which a second user is selected at random. The contest creator 808 may select from a pool of possible other users in a round-robin, first-come-first-served, or any other manner. The second user may be selected to ensure that at least one athlete is different in the selections between the first and second users.

A user may also select a one-to-many contest in which more than two users participate. The user may invite a plurality of other users (via an in-app link, email, phone, or social media, as discussed above) or a plurality of random users may be selected (in accordance with, in one embodiment, a number of other users selected by the first user) and the contest creator 808 may select the designated number of other random users. In one-to-many contests, the top-scoring user may be designated as the winner or a number of top-scoring users may all be selected as winners. In one embodiment, the user is presented with a menu or list of open/pending contests (also known as a “lobby”) and may select a game from said list to join. In another embodiment, the contest creator 808 automatically selects a contest for the user, and the user need not perform the additional step of selecting a contest in the lobby.

The contest creator 808 may specify when contents are to start. In one embodiment, a set time of the day or week is designated as the contest start time for all participants of a given sport. For example, football contests may be deemed to start weekly every Friday at 9 AM Pacific Time. When contests start, the contest creator may lock any projections currently varying based on, for example, weather conditions or injury reports. In some embodiments, the contest creator 808 allows users to vary their rosters until a set point after the start of the contest such as, for example, the start of the first game in which selected athletes play. If an athlete is injured and cannot participate in an event, the contest creator may permit any users who have selected that athlete to replace him or her with another athlete, such as one having a similar number of projected points.

In one embodiment, a handicap computer 810 equalizes scores across users. A first user may, for example, select three athletes having a high projected point value total (say, 100 points) while a second user selects three athletes having a low projected point value (say, 10 points). In one embodiment, the handicap computer 810 determines the difference between the two projected point values (here, 90 points) and adds that value to the points of the second user such that both the first and second user begin the contest with the same number of points (here, 100 points). Thus, if the athletes selected by the second user beat their projected point value by 4 points, while the athletes selected by the first user beat their projected point value by only 2 points, the second user is deemed the winner of the contest with 104 points (versus the first user's 102 points) despite the fact that, without the handicap equalization, the sum of the points by the second user is only 14.

The contest scorer 812 may determine the winner of the contest in accordance with the above description or via any other means. For example, in an alternative environment, the differential between the projected and actual point values is tracked instead of the absolute number of points. In the preceding example, the second user would again be deemed the winner because his or her differential (4 points) is greater than the differential of the first user (2 points). In this embodiment, the users may be shown, via a user interface, only the differential point values (e.g., the left-hand column of FIG. 5) instead of the absolute number of points (e.g., the right-hand column of FIG. 5) to avoid confusion.

In another embodiment, the contest scorer 812 determines the contest winner based on a percentage improvement over a projected number of points. For example, if the roster of the first user earned 102 points while the roster of the second user earned 11 points (from projected values of, again 100 and 10 points), the first user would be deemed the winner using the methods described above. In this embodiment, however, the roster of the first user showed only a 2% improvement over the projection while the roster of the second user showed a 10% improvement, and the second user is deemed the winner. The users may select one of these (or other) methods of computing scores and winners prior to the contest starting.

In the event of a tie of points between users, the contest scorer 812 may break the tie using other data, such as the total point spread in games played by the selected athletes, or any other such data. In other embodiments, the contest may be deemed a “push.”

In some embodiments, a variety of factors may go into determining a projected score for an athlete, and a user may be able to adjust those factors to view how those adjustments may affect a projection. For example, if an official projection indicates that weather may have an effect on the play of a game (causing some events to happen that would not otherwise have happened without that weather condition), a user may be able to turn the weighing of the weather condition to zero to see how the play would have been projected to occur without the weather. A user may use that information to make an athlete selection. For example, if the user thinks that weather will, in fact, not affect a quarterback's performance as much as projected, the user may set the weighting to the weather characteristic to zero and, if that results in a higher projected performance, the user may then select the player at issue believing that the official projection actually projects a score that is too low.

The contest scorer 812 may also distribute prizes to winning users. In one embodiment, the user participates in the contest for free and, upon winning, is awarded (e.g.) an entry into a prize drawing, a coupon, a gift certificate, or other such non-cash award. The contest scorer 812 may, in these embodiments, set a maximum number of times that a given user can win each type of prize (or total number of prizes).

In other embodiments, users may pay an entry fee to enter a contest having a cash prize. The amount of money may be selected from a fixed list of values (e.g., $1, $2, $5, $10, $50, or $100) or may be any number entered by the user. In one embodiment, a user playing for a cash prize is paired with one or more other users and, if the user wins, the user is awarded with a certain percentage of the total cash prize, the remainder being paid to the operator of the server 800 or partner thereof as a contest-management fee. For example, if two users each pay $5 to enter a one-to-one contest, the winning user may collect $9 as a prize and the operator $1 as a management fee. The funds may be withdrawn from and potentially awarded to an online financial account associated with each user, such as an electronic bank account, a credit-card account, a PAYPAL account, a BITCOIN account, or a GOOGLE WALLET account (or any similar accounts).

FIG. 8 illustrates a method 900 in accordance with embodiments of the present invention. In a first step 902, a set of projected performance data for an upcoming performance of real-world athletes is stored in a computer database. In a second step 904, a projected point value corresponding to the projected performance of each real-world athlete is computing using a computer processor for each real-world athlete. The projected point values may be transmitted, using an electronic network, to a client device of a user, and a selection of real-world athletes to be included in the fantasy-sports game may be received back from the user. In a third step 906, first and second projected fantasy-sports point totals corresponding to a total projected point value of the real-world athletes selected by first and second users may be determined. In a fourth step 908, a difference between the first and second projected fantasy-sports point totals may be equalized by providing a handicap to the lesser of the first and second projected fantasy-sports point totals. In a fifth step 910, a winner of the fantasy-sports game, after the upcoming performance of the real-world athletes has occurred, is determined based on whether fantasy-sports points earned by the selection of the user exceeds fantasy-sports points earned by the selection of the competing user when the handicap is included.

Embodiments of the present invention are not limited to only sporting events. Any event or activity that generates trackable or quantifiable data and for which a prediction can be made about future generation of said data is within the scope of the present invention; users may compete based on actual data out-performing the predicted data. Such events or activities include but are not limited to stock-market prices, commodity-market prices, weather predictions, political elections and campaigns, or any other events. In one embodiment, a set of point values are created for events in reality-television shows (e.g., a character crying, throwing wine, kissing, screaming, mentioning money, or other similar events), and users may select one or more characters and compete based on whether those characters meet or exceed their predicted point values.

It should also be noted that embodiments of the present invention may be provided as one or more computer-readable programs embodied on or in one or more articles of manufacture. The article of manufacture may be any suitable hardware apparatus, such as, for example, a floppy disk, a hard disk, a CD ROM, a CD-RW, a CD-R, a DVD ROM, a DVD-RW, a DVD-R, a flash memory card, a PROM, a RAM, a ROM, or a magnetic tape. In general, the computer-readable programs may be implemented in any programming language. Some examples of languages that may be used include C, C++, or JAVA. The software programs may be further translated into machine language or virtual machine instructions and stored in a program file in that form. The program file may then be stored on or in one or more of the articles of manufacture.

Certain embodiments of the present invention were described above. It is, however, expressly noted that the present invention is not limited to those embodiments, but rather the intention is that additions and modifications to what was expressly described herein are also included within the scope of the invention. Moreover, it is to be understood that the features of the various embodiments described herein were not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

What is claimed is:

1. A method for conducting a fantasy-sports game, the method comprising:
storing, in a computer database, a set of projected performance data for an upcoming performance of real-world athletes;
computing using a computer processor, for each real-world athlete, a projected point value corresponding to the projected performance of each real-world athlete;
transmitting using an electronic network, to a client device of a user, the projected point values;
receiving, from the client device of the user, a selection of real-world athletes to be included in the fantasy-sports game;
determining a first projected fantasy-sports point total corresponding to a total projected point value of the real-world athletes selected by the user;
determining a second projected fantasy-sports point total corresponding to a total projected point value of the real-world athletes selected by a competing user;
equalizing a difference between the first and second projected fantasy-sports point totals by providing a handicap to the lesser of the first and second projected fantasy-sports point totals; and
determining a winner of the fantasy-sports game, after the upcoming performance of the real-world athletes has occurred, based on whether fantasy-sports points earned by the selection of the user exceeds fantasy-sports points earned by the selection of the competing user when the handicap is included.

2. The method of claim 1, wherein the number of real-world athletes selected by the user is three, five, or seven.

3. The method of claim 1, wherein the real-world athletes compete in football, baseball, basketball, or hockey.

4. The method of claim 1, wherein providing the handicap comprises awarding the user having a lower projected fantasy-sports point total additional points equal to a difference between the first projected fantasy-sports point total and the second projected fantasy-sports point total.

5. The method of claim 1, wherein providing the handicap comprises tracking differences between (i) the first projected fantasy-sports point total and points earned by the selection of the user and (ii) the second projected fantasy-sports point total and points earned by the selection of the competing user and selecting the greater of the two differences.

6. The method of claim 1, wherein the upcoming performance comprises a part of a game, a game, or a series of games.

7. The method of claim 1, wherein the selected real-world athletes comprise one sports league or a plurality of sports leagues.

8. The method of claim 1, wherein determining the winner comprises comparing an absolute number of points or a percentage increase in points.

9. The method of claim 1, wherein determining the winner comprises selecting the user having the highest or lowest number of points.

10. The method of claim 1, further comprising awarding a cash or rewards-points prize to the winner.

11. A system for conducting a fantasy-sports game, the system comprising:
a computer database for storing a set of projected performance data for an upcoming performance of real-world athletes; and
a computer processor for executing software instructions for:
i. computing, for each real-world athlete, a projected point value corresponding to the projected performance of each real-world athlete;
ii. transmitting using an electronic network, to a client device of a user, the projected point values;
iii. receiving, from the client device of the user, a selection of real-world athletes to be included in the fantasy-sports game;
iv. determining a first projected fantasy-sports point total corresponding to a total projected point value of the real-world athletes selected by the user;
v. determining a second projected fantasy-sports point total corresponding to a total projected point value of the real-world athletes selected by a competing user;
vi. equalizing a difference between the first and second projected fantasy-sports point totals by providing a handicap to the lesser of the first and second projected fantasy-sports point totals; and
vii. determining a winner of the fantasy-sports game, after the upcoming performance of the real-world athletes has occurred, based on whether fantasy-sports points earned by the selection of the user exceeds fantasy-sports points earned by the selection of the competing user when the handicap is included.

12. The system of claim 11, wherein the number of real-world athletes selected by the user is three, five, or seven.

13. The system of claim 11, wherein the real-world athletes compete in football, baseball, basketball, or hockey.

14. The system of claim 11, wherein providing the handicap comprises awarding the user having a lower projected fantasy-sports point total additional points equal to a difference between the first projected fantasy-sports point total and the second projected fantasy-sports point total.

15. The system of claim 11, wherein providing the handicap comprises tracking differences between (i) the first projected fantasy-sports point total and points earned by the selection of the user and (ii) the second projected fantasy-sports point total and points earned by the selection of the competing user and selecting the greater of the two differences.

16. The system of claim 11, wherein the upcoming performance comprises a part of a game, a game, or a series of games.

17. The system of claim 11, wherein the selected real-world athletes comprise one sports league or a plurality of sports leagues.

18. The system of claim 11, wherein determining the winner comprises comparing an absolute number of points or a percentage increase in points.

19. The system of claim 11, wherein determining the winner comprises selecting the user having the highest or lowest number of points.

20. The system of claim 11, wherein the processor is further configured for awarding a cash or rewards-points prize to the winner.
